(19) United States
(12) Patent Application Publication
(10) Pub. No.: US 2023/0089250 A1
(43) Pub. Date: Mar. 23, 2023

(54) FUEL LOADING HOSE REEL SYSTEMS, METHODS AND APPARATUS

(71) Applicant: Westmor Industries, LLC, Morris, MN (US)

(72) Inventors: Abe Wruck, Morris, MN (US); Reid Brandborg, Morris, MN (US)

(21) Appl. No.: 17/934,392

(22) Filed: Sep. 22, 2022

Related U.S. Application Data
(60) Provisional application No. 63/261,471, filed on Sep. 22, 2021.
(60) Provisional application No. 63/262,610, filed on Oct. 15, 2021.
(60) Provisional application No. 63/262,837, filed on Oct. 21, 2021.

(51) Int. Cl. B60P 3/22; B65H 75/42; B65H 75/44; F16L 27/08

(52) U.S. Cl. CPC B60P 3/2265; B65H 75/425; B65H 75/4478; B65H 75/4463; F16L 27/0824; B65H 2701/33; B65H 2402/42; B65H 2402/351

(57) ABSTRACT

Systems, methods and apparatus are provided for liquid product delivery. In some embodiments a conduit assembly disposed partly beneath a deck or platform is fluidly coupled to a reel assembly via a rotary fluid coupler.

### PRIORITY INFORMATION

This application claims priority to U.S. Provisional Application No. 63/261,471, filed Sep. 22, 2021, U.S. Provisional Application No. 63/262,610, filed Oct. 15, 2021 and U.S. Provisional Application No. 63/262,837, filed Oct. 21, 2021.

### BACKGROUND

Hose reels are used to support hoses for loading and unloading liquid product (e.g., fuel, fertilizer, propane, NH3, etc.) from liquid product transport vehicles.

### BRIEF DESCRIPTION OF THE DRAWINGS

FIG. 1 is a rear elevation view of an embodiment of hose reel supported on a rear deck of a liquid product transport vehicle.

FIG. 2 is a partially cut away side elevation view of the hose reel of FIG. 1.

FIG. 3 is a partially cut away plan view of the hose reel of FIG. 1.

FIG. 4 is a perspective view of the liquid product transport vehicle and hose reel of FIG. 1 in more detail.

FIG. 5 is a top view of the liquid product transport vehicle and hose reel of FIG. 1 with certain components not shown.

FIG. 6 is a sectional view of the liquid product transport vehicle and hose reel of FIG. 1 along section 6-6 of FIG. 5.

FIG. 7 is a side elevation view of an embodiment of a liquid product transport trailer supporting an embodiment of a hose reel.

FIG. 8 is a rear elevation view of an embodiment of a hose reel supporting a user interface and pivotally supported on a liquid product transport trailer.

FIG. 9 is a rear elevation view of an embodiment of a hose reel supporting a user interface and pivotally supported on a deck of a liquid product transport vehicle.

### DESCRIPTION

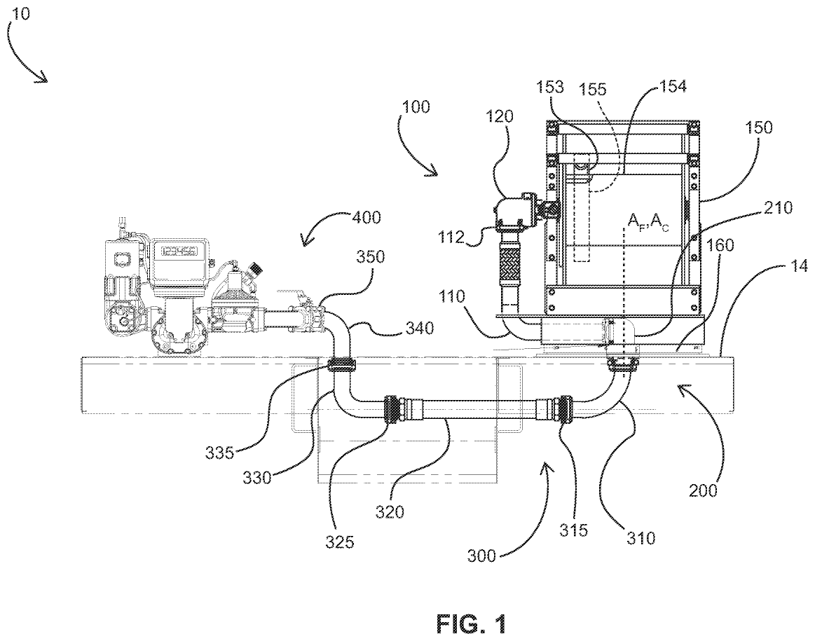

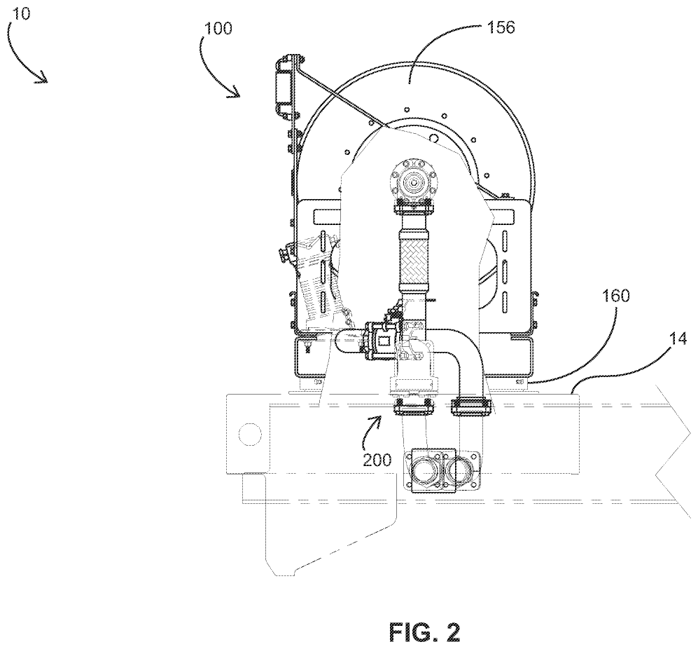

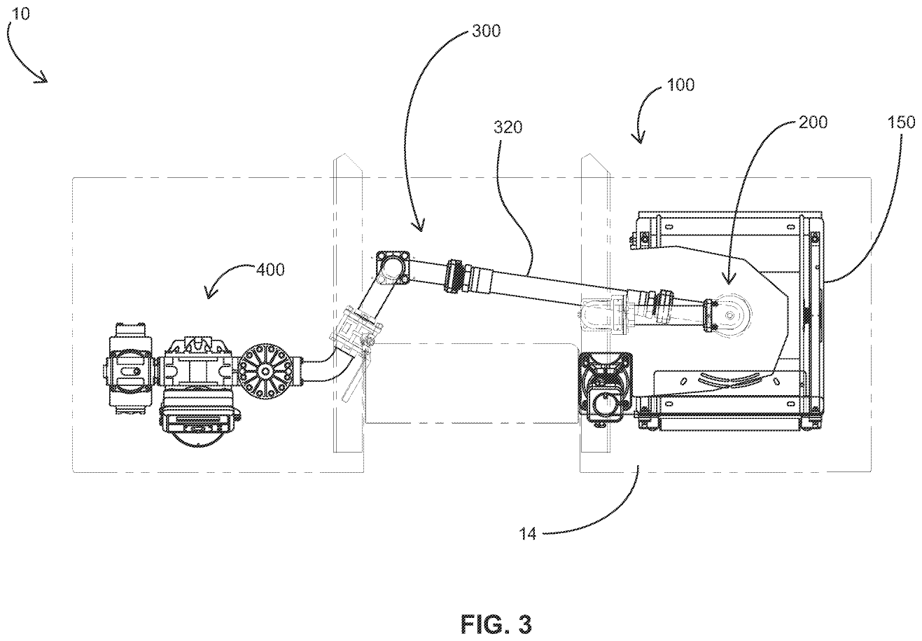

Referring to the drawings, wherein like reference numerals designate identical or corresponding parts throughout the several views, FIGS. 1-3 illustrate an embodiment of a reel assembly 100 supported on the deck 14 of a liquid product transport vehicle 10. The reel assembly optionally includes a reel frame 150 pivotally supporting a reel drum 154. The reel assembly (e.g., the reel drum 154 thereof) optionally supports a flexible liquid product hose 155 (e.g., wrapped about the reel in a generally spiral configuration) such that the hose 155 can be reeled into a stored configuration on the reel or extended into an extended and/or partially extended configuration (e.g., for connection to liquid product container separate from vehicle 10). First and second side plates 156 are optionally mounted to the reel drum 154 and disposed to retain the hose 155 on the reel drum. The reel drum 154 is optionally configured (e.g., by operably coupling to an electrical, hydraulic or spring return system) to be retracted and/or automatically retract hose 155 into the stored configuration after extension of the hose 155 into the partially extended configuration. The hose 155 is optionally in fluid communication with a liquid product vessel 20 of the liquid product transport vehicle 10, e.g., via a conduit assembly 300 and/or a meter 400 configured to measure a volume of liquid product transferred via the hose 155.

In some embodiments, the reel assembly 100 is pivotally supported on the deck 14 such that the reel frame 150 is pivotable about a generally vertical reel frame pivot axis A_{F}. In some embodiments the reel frame 150 is supported on a turntable 160 (e.g., centered on the reel frame pivot axis A_{F}) which is in turn optionally at least partially supported on (e.g., mounted to) the deck 14. The turntable 160 optionally comprises a ball bearing type turntable such as model no. 650L from Jost in Grand Haven, Mich.

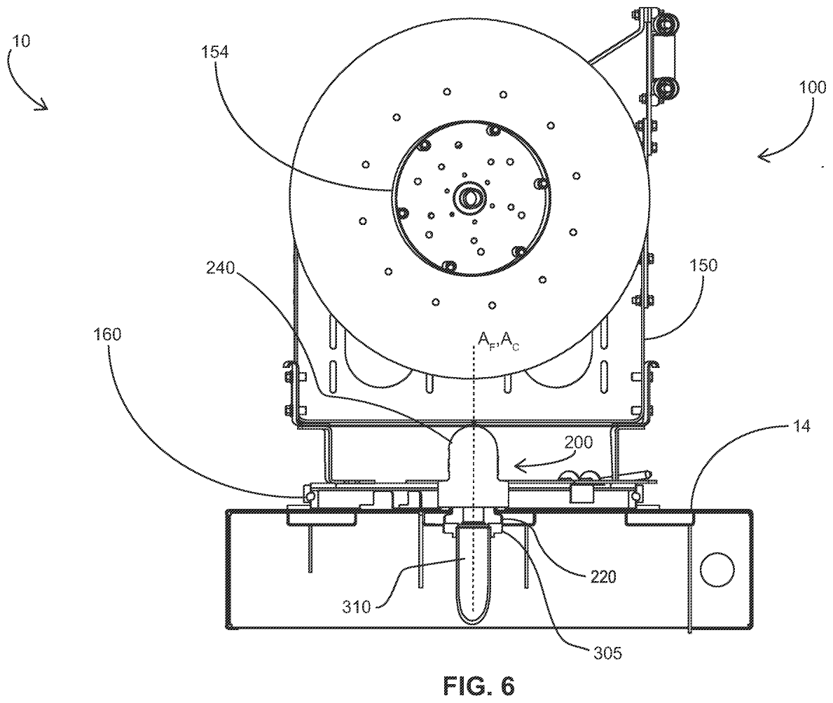

In some embodiments, the conduit assembly 300 is disposed at least partially beneath a surface level of the deck 14. The conduit assembly 300 optionally comprises a conduit 310 fluidly coupled to the reel assembly via a rotary fluid coupler 200. The rotary fluid coupler 200 optionally includes an upper portion 240 (see FIG. 6) configured to pivot relative to a lower portion 220 about a generally vertical fluid coupler axis A_{C}. The fluid coupler axis A_{C} is optionally coaxial with the reel frame pivot axis A_{F}.

The conduit assembly 300 optionally comprises a conduit 320 coupled (e.g., by a flange connector or other connector 315) to the conduit 310. The conduit assembly 300 optionally comprises a conduit 330 coupled (e.g., by a flange connector or other connector 325) to the conduit 320. The conduit assembly 300 optionally comprises a conduit 340 coupled (e.g., by a flange connector or other connector 335) to the conduit 330. The conduit 340 is optionally in fluid communication with meter 350, e.g., via a shut-off valve 400 configured to selectively shut off fluid flow between the meter 400 and conduit assembly 300.

The rotary fluid coupler 200 is optionally in fluid communication with hose 155 via one or more conduits 110 which are optionally supported on and/or pivot with the reel frame 150. The conduit 110 is optionally fluidly coupled to a coupler 153 (e.g., fixed coupler) via a rotary fluid coupler 120. The conduit 110 is optionally coupled to coupler 120 at a flange 112 provided on coupler 120. The hose 155 is optionally fluidly coupled (e.g., removably fluidly coupled) to the coupler 153 and thus in fluid communication with tank 20.

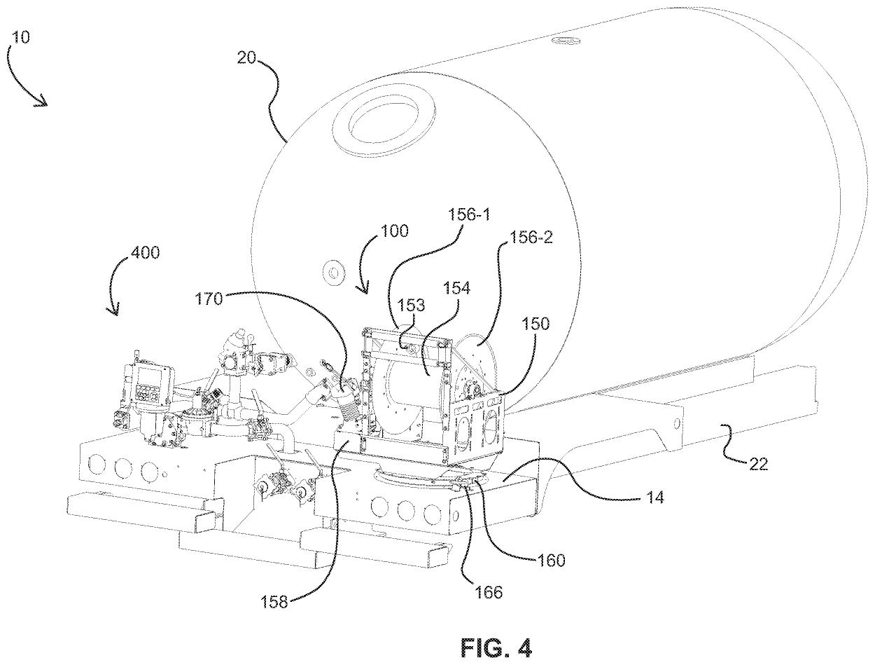

Referring to FIGS. 4-6, the vehicle 10 and reel assembly 100 are shown in more detail. Referring to FIG. 4, the liquid product vessel 20 is supported on a chassis 22 (e.g., a wheeled chassis comprising one or more rails). Referring to FIG. 4, a nozzle holster 170 is optionally supported on a platform 158 supported on frame 150. In some embodiments, additional controls (e.g., electronic, hydraulic, etc.) and/or storage (e.g., component storage, etc.) are supported on and pivot with the frame 150.

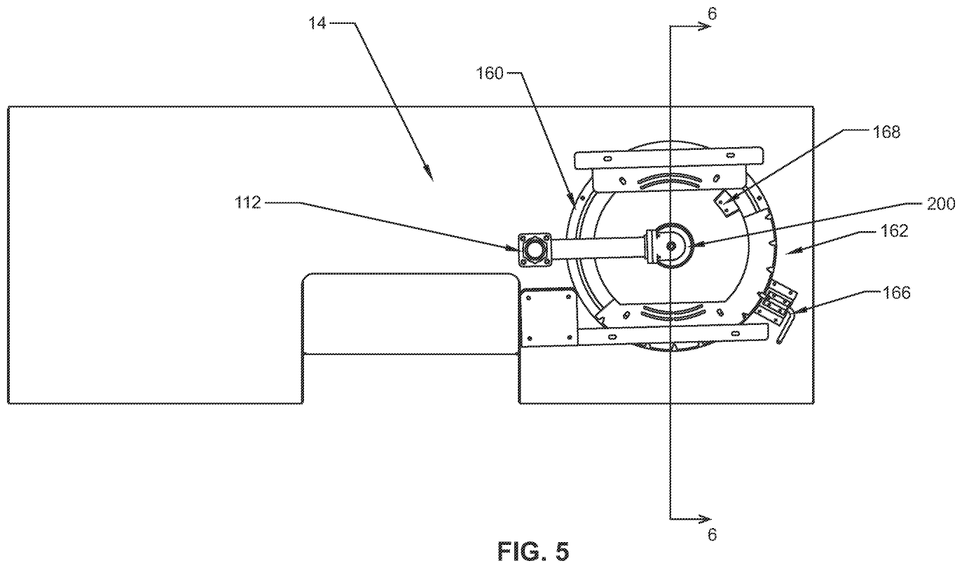

Referring to FIG. 5, in some embodiments an incremental pivot stopper 166 is mounted to deck 14 and configured to selectively engage one of a plurality of notches 162 or other stop features provided on the turntable 160 in order to selectively retain the reel assembly 100 in one of a plurality of pivotal positions. In some embodiments affixed pivot stopper 168 is supported on the turntable 160 deck and disposed to engage a stopper (not shown) supported on the deck 14 in order to prevent pivoting of the reel assembly 100 beyond a fixed range of pivotal motion.

Referring to FIG. 6, the rotary fluid coupler 200 (which may be referred to as a swivel) optionally comprises a lower portion 220 pivotally coupled to and fluidly coupled to an upper portion 240. In some embodiments the rotary fluid coupler 200 comprises a swivel such as model no. ME854S-4B-4B available from MEC in Marshall, Mich. The rotary fluid coupler 200 optionally comprises one or more of a sealed ball bearing and a dynamic seal. The lower portion 220 optionally comprises a flange. The lower portion 220 of rotary fluid coupler 200 is optionally coupled to a socket flange 305 (e.g., by bolts or other fasteners). The socket flange 305 is optionally fluidly coupled (e.g., by welding) to conduit 310.

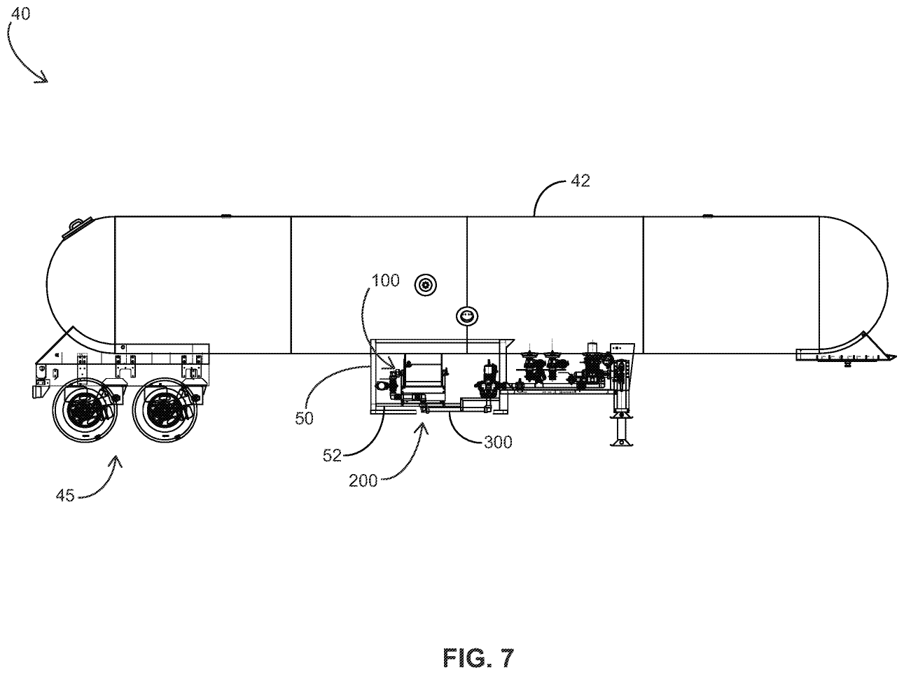

Referring to FIG. 7, the reel assembly 100 is shown illustrated supported on a liquid product transport trailer 40 (e.g., having a rear wheel assembly 45). The reel assembly 100 is optionally in fluid communication with a vessel 42 of the liquid product transport trailer 40 via a modified conduit assembly 300′. The conduit assembly 300′ is optionally in fluid communication with a hose supported on reel assembly 100 via a rotary fluid coupler 200. The reel assembly 100 is optionally rotatably supported (e.g., by a turntable 160) on a platform 52 of a substructure 50 mounted to an underside of the vessel 42. In some embodiments, the reel assembly 100 includes a selectively engageable locking mechanism for alternately locking the reel assembly into one of a first position in which the reel is oriented toward a first lateral side of the vessel 42 (e.g., as illustrated) and a second position in which the reel is oriented toward a second lateral side of the vessel 42 (e.g., facing the opposite direction from that illustrated).

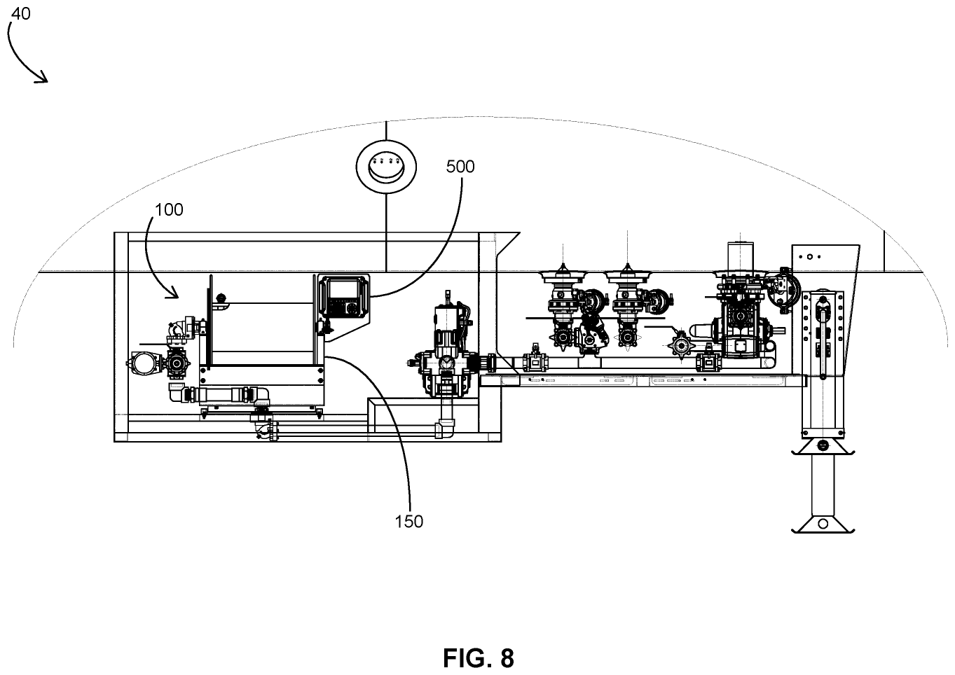

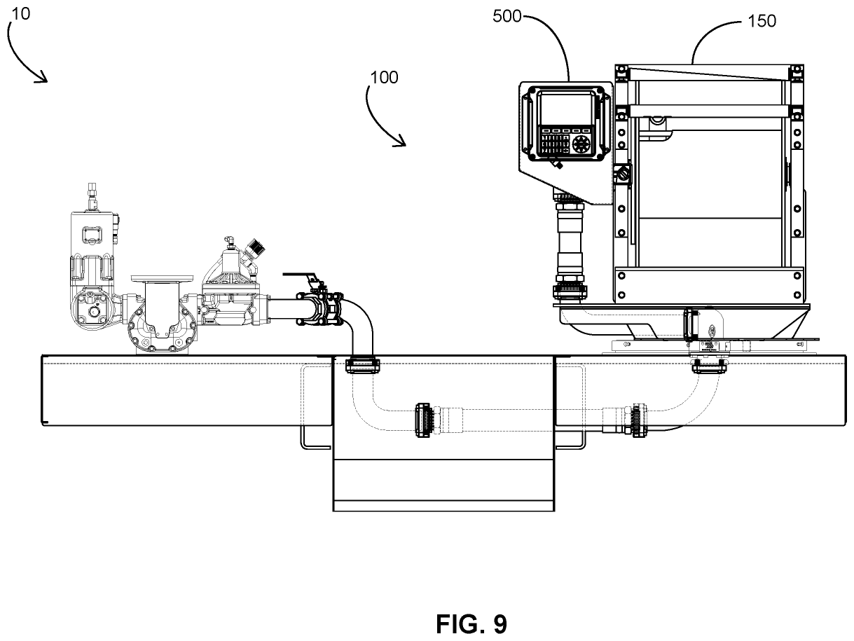

Referring to FIGS. 8 and 9, in some embodiments the reel assembly 100 (e.g., the frame 150 thereof) optionally supports a user interface 500 such that the user interface pivots with the reel frame 150. The user interface 500 (e.g., register, meter, etc.) optionally comprises a graphical user interface having a display, CPU, user input (e.g., keypad), memory, etc. The user interface 500 is optionally configured to display to a user and/or allow a user to enter data. The user interface 500 is optionally in data communication with one or more sensors configured to measure one or more product characteristics and/or one or more product delivery characteristics (e.g., product flow rate). In some embodiments, the user interface 500 comprises a register (e.g., digital register) such as the model no. LCR.iQP available from Liquid Controls in Lake Bluff, Ill.

Although various embodiments have been described above, the details and features of the disclosed embodiments are not intended to be limiting, as many variations and modifications will be readily apparent to those of skill in the art. Accordingly, the scope of the present disclosure is intended to be interpreted broadly and to include all variations and modifications within the scope and spirit of the appended claims and their equivalents. For example, any feature described for one embodiment may be used in any other embodiment.

1. A liquid product delivery system supportable on a deck of a liquid product transport vehicle having a liquid product vessel, the liquid product delivery system comprising:
a liquid product reel frame configured to support a liquid product delivery hose, said liquid product reel frame having a fluid coupler configured to be in fluid communication with said liquid product delivery hose;
a turntable supported on said deck, said turntable supporting said liquid product reel frame such that said liquid product reel frame is pivotable about a turntable axis;
a conduit assembly disposed at least partially below the surface of said deck, said conduit assembly being in fluid communication with the liquid product vessel;
a swivel, said swivel fluidly coupling said conduit assembly to said fluid coupler, said swivel having a first portion coupled to said turntable, said swivel having a second portion coupled to said conduit assembly, wherein said first portion is pivotally coupled to said second portion such that said first portion is pivotable about a swivel axis, wherein said swivel axis is coaxial with said turntable axis.

2. The liquid product delivery system of claim 1, further comprising:
a user interface comprising a graphical user interface, wherein said reel frame supports said user interface such that said user interface pivots with said reel frame.

3. The liquid product delivery system of claim 1, wherein said turntable comprises a plurality of stop features, the liquid product delivery system further comprising:
an incremental pivot stopper mountable to said deck, said incremental pivot stopper being configured to selectively engage one of said plurality stop features provided on the turntable.

4. The liquid product delivery system of claim 1, wherein said swivel comprises a sealed ball bearing.

5. The liquid product delivery system of claim 1, wherein said swivel comprises a dynamic seal.

6. A liquid product delivery vehicle comprising:
a wheeled chassis;
a liquid product vessel supported on said chassis;
a deck supported on said chassis, said deck disposed at least partially rearward of said vessel;
a liquid product reel frame configured to support a liquid product delivery hose, said liquid product reel frame having a fluid coupler configured to be in fluid communication with said liquid product delivery hose;
a turntable supported on said deck, said turntable supporting said liquid product reel frame such that said liquid product reel frame is pivotable about a turntable axis;
a conduit assembly disposed at least partially below the surface of said deck, said conduit assembly being in fluid communication with the liquid product vessel; and
a swivel, said swivel fluidly coupling said conduit assembly to said fluid coupler, said swivel having a first portion coupled to said turntable, said swivel having a second portion coupled to said conduit assembly, wherein said first portion is pivotally coupled to said second portion such that said first portion is pivotable about a swivel axis, wherein said swivel axis is coaxial with said turntable axis.

7. The liquid product delivery system of claim 6, further comprising:
a user interface comprising a graphical user interface, wherein said reel frame supports said user interface such that said user interface pivots with said reel frame.

8. The liquid product delivery system of claim 6, wherein said turntable comprises a plurality of stop features, the liquid product delivery system further comprising:
an incremental pivot stopper mountable to said deck, said incremental pivot stopper being configured to selectively engage one of said plurality stop features provided on the turntable.

9. The liquid product delivery system of claim 6, wherein said swivel comprises a sealed ball bearing.

10. The liquid product delivery system of claim 6, wherein said swivel comprises a dynamic seal.

11. A liquid product delivery system supportable on a platform of a liquid product transport trailer having a liquid product vessel, the platform disposed beneath the liquid product vessel, the liquid product delivery system comprising:
a liquid product reel frame configured to support a liquid product delivery hose, said liquid product reel frame having a fluid coupler configured to be in fluid communication with said liquid product delivery hose;
a turntable supported on said platform, said turntable supporting said liquid product reel frame such that said liquid product reel frame is pivotable about a turntable axis;
a conduit assembly disposed at least partially below the surface of said platform, said conduit assembly being in fluid communication with the liquid product vessel;
a swivel, said swivel fluidly coupling said conduit assembly to said fluid coupler, said swivel having a first portion coupled to said turntable, said swivel having a second portion coupled to said conduit assembly, wherein said first portion is pivotally coupled to said second portion such that said first portion is pivotable about a swivel axis, wherein said swivel axis is coaxial with said turntable axis.

12. The liquid product delivery system of claim 11, further comprising:
a user interface comprising a graphical user interface, wherein said reel frame supports said user interface such that said user interface pivots with said reel frame.

13. The liquid product delivery system of claim 11, wherein said turntable comprises a plurality of stop features, the liquid product delivery system further comprising:
an incremental pivot stopper mountable to said deck, said incremental pivot stopper being configured to selectively engage one of said plurality stop features provided on the turntable.

14. The liquid product delivery system of claim 11, wherein said swivel comprises a sealed ball bearing.

15. The liquid product delivery system of claim 11, wherein said swivel comprises a dynamic seal.
